(19) United States
(12) Patent Application Publication
(10) Pub. No.: US 2004/0025388 A1
(43) Pub. Date: Feb. 12, 2004

(54) Display means

(76) Inventor: Alan Bernard Coates, Waterloo (AU)

Correspondence Address: DARBY & DARBY P.C., P. O. BOX 5257, NEW YORK, NY, 10150-5257, US

(21) Appl. No.: 10/343,062

(22) PCT Filed: Jul. 24, 2001
(86) PCT No.: PCT/AU01/00900

(30) Foreign Application Priority Data
Jul. 25, 2000 (AU) PQ9002

(51) Int. Cl. G09F 11/12

(52) U.S. Cl. 40/524; 40/472

(57) ABSTRACT

A display means (11) for use in a display device (17), includes a support sheet (11) with at least one transparent region (5,6). A retaining means (2) is located about at least part of the periphery of each transparent region (5,6). Transparency means is adapted to be retained by the retaining means (2), the transparency means including an image to be viewed through a respective transparent region (5,6) of the device. The retaining means (2) includes a plurality of retaining ears positioned about the periphery of each transparent region.

### TECHNICAL FIELD

The present invention relates to a display means, and in particular, to a display means which can be used to display a plurality of images. The display means of the present invention is particularly suited to, but not limited to, use in a rotating menu board in a fast food restaurant, such as in the display device as described in WO94/28534.

### BACKGROUND OF THE INVENTION

Fast food outlets typically utilise menu boards positioned behind and/or above the serving counter. Many such fast food outlets display two or more menus during different periods of the day, for instance, at breakfast, and, at lunch and/or dinner.

A number of rotating menu boards have hereinbefore been designed for such uses, including the Applicant's earlier Patent specification WO94/28534, the entire disclosures of which should be considered to be incorporated herein by this reference thereto.

WO94/28534 describes a display device having a pair of rotatable roller members, to tightly support and have a carrier rotate thereabouts. Illumination means is provided behind at least a portion of the carrier to illuminate a viewing portion of the carrier, such that an image can be viewed.

Certain features of the display device of WO94/28534 are shown in FIG. 1.

### SUMMARY OF THE INVENTION

The present invention seeks to provide display means which may be utilised in conjunction with the display device of WO94/28534, or in other display devices.

The present invention seeks to provide a display means which enables the manufacture and/or use of a display means which is easily modified for displaying varying images.

In one broad form, the present invention provides a display means, including:

a support sheet, having at least one substantially transparent region;

retaining means, located about at least part of the periphery of each transparent region; and,

transparency means, adapted to be retained by each said retaining means, said transparency means including an image to be viewed through a respective transparent region of said support sheet.

Preferably, said retaining means includes a plurality of retaining ears positioned about the periphery of each transparent region.

Also preferably, said retaining ears are positioned at corner positions and/or at locations intermediate, either centrally or otherwise, or said corner positions of said transparent region(s).

Preferably, said retaining ears are positioned substantially entirely along at least two sides of the periphery of said transparent region(s).

The display device of the present invention preferably further includes image divider means, embodied as a sheet member adapted to be retained proximal to said support sheet by said retaining means, said image divider means including at least one opaque border to visibly divide a transparent region of said support sheet into a plurality of regions for display of transparencies therethrough.

Preferably, said display means is substantially flexible and adapted to be supported on a carrier means of a display device (as described in WO94/28534).

Also preferably, said image provided on said transparency includes a picture, design, advertising material or other image.

Preferably, said retaining ears are applied to said support sheet be adhesive, welding or by other application method(s).

Also preferably, said support sheet is formed to have transparent region(s) by applying an opaque material to particular regions of a transparent sheet material, either by a layer of adhesive material such as a laminate, by screen printing onto said transparent sheet, or the like.

Preferably, said sheet material and/or said transparency means is substantially formed of flexible material such as polyvinylchloride, polycarbonate and/or polypropylene sheet material or like material.

In a further broad form, the present invention provides a method of manufacturing a display means.

In yet a further broad form, the present invention provides a method of using/changing displayed images using a display means.

### DESCRIPTION OF THE DRAWINGS

The present invention will become more fully understood from the following detailed description of preferred but non-limiting embodiments thereof, described in connection with the accompanying drawings, wherein:

FIG. 1 shows a schematic perspective view of the display device of WO94/28534 with which the display means of the present invention may be utilised;

FIG. 2 shows a resultant appearance of a display means of the present invention, in situ, displaying eight smaller and one larger image;

FIG. 3 illustrates the support sheet of the display means in accordance with the present invention as illustrated in FIG. 2;

FIG. 4 illustrates the various components of the display means of the present invention in accordance with the embodiment of FIG. 2;

FIG. 5 illustrates, in FIGS. 5(a), 5(b), 5(c) and 5(d), the various steps in installing the transparencies to the support sheet of the display means as illustrated in FIG. 2;

FIG. 6 illustrates an alternative preferred embodiment to that of FIG. 2, wherein ten equally sized images are displayed in the display device of FIG. 6;

FIG. 7 illustrates a similar representation to that of FIG. 1, illustrating that the support sheet utilised in the embodiment of FIG. 6 is similar to the support sheet utilised in the embodiment of FIG. 2;

FIG. 8 illustrates the various components used in the display means of the embodiment of FIG. 6;

FIG. 9 illustrates, in FIGS. 9(a), 9(b), 9(c) and 9(d), the steps in achieving the display means illustrated in the FIG. 6;

FIG. 10 illustrates a preferred embodiment of the retaining means of the display means in accordance with the present invention; and,

FIG. 11 illustrates the insertion of a translite into a display device.

### DETAILED DESCRIPTION OF PREFERRED EMBODIMENT

Throughout the drawings, like numerals will be used to identify similar features, except where expressly otherwise indicated.

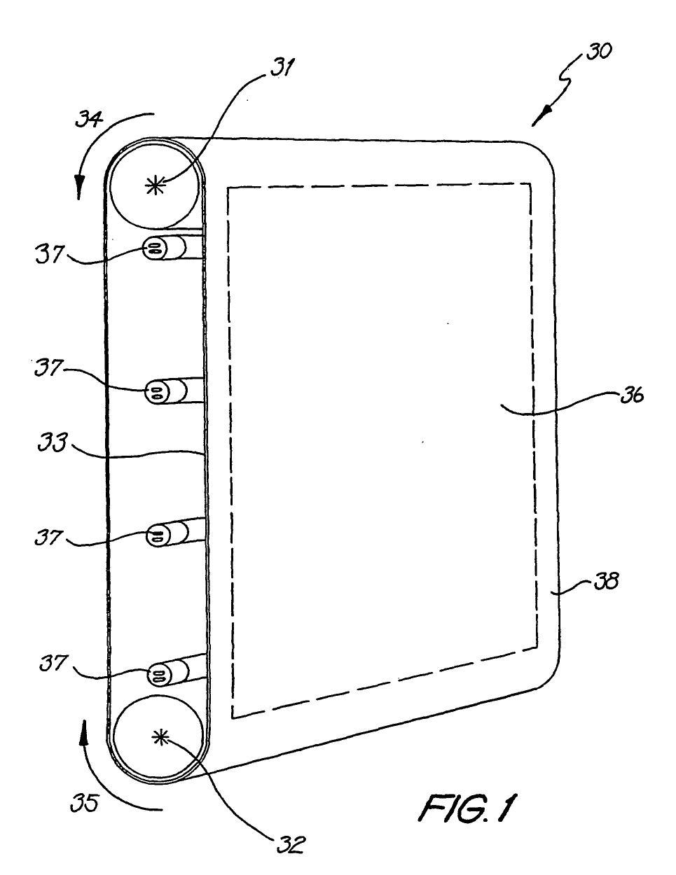

FIG. 1 illustrates a display device, in accordance with that described in WO94/28534. Despite only FIG. 1(a) of that prior art document being incorporated herein, the entire disclosures of WO94/28534 should be considered to be incorporated within the present specification by this reference thereto.

WO94/28534, owned by the proprietor of the present invention, describes a display device 30, including a pair of rotatable roller members 31 and 32, located in parallel spaced apart relationship. A carrier means 33 is mounted between the roller members 31 and 32 in a belt like manner. The carrier means is adapted to receive at least one display means thereon, each of the carrier means and display means being constructed at least partially of substantially flexible and translucent material. An illumination means 37, is further provided behind at least a portion of the carrier means 33 to illuminate a viewing portion of the carrier means and the display means thereon.

The present invention seeks to provide a display means which can be utilised in conjunction with the display device of FIG. 1(a). However, the display means could be utilised other than with the display device of WO94/28534, for example, separately or with other display devices.

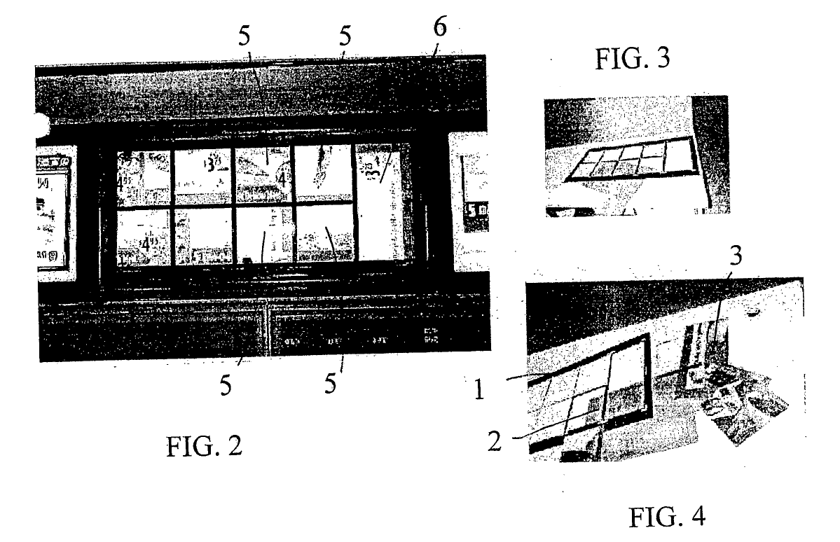

FIG. 2 illustrates a display device constructed in accordance with the schematic perspective view of FIG. 1, in this case, illustrating the provision of eight equally sized smaller images, illustrated by reference number 5, and one larger image, indicated by reference numeral 6.

The display means of the present invention includes a support sheet 1, retaining means 2, and transparencies 3 (see FIG. 4). The support sheet 1 has a plurality of transparent regions. In particular, the support sheet illustrated in FIGS. 2 to 5 illustrates the provision of eight similarly sized smaller regions 5, and one larger region 6. Retaining means 2 are shown to be positioned about the periphery of each transparent region 5 and 6, to support transparencies, such that the transparencies may be viewed through the respective transparent regions 5 and 6 of the support sheet 1, when displayed in the manner as shown in FIG. 2. As illustrated in FIG. 4, the retaining means may include a plurality of retaining ears. The particular retaining ears shown in FIG. 4 are shown to be provided at the corner positions of each transparent region, and, for the larger transparent region 6, intermediate the longitudinal edges. It will, however, be appreciated by persons skilled in the art that a variety of retaining ears can be embodied, other than the specific retaining ears illustrated herein. For example, the retaining means could be positioned at discrete locations about the periphery of each transparent region, or, the retaining ears could be elongate means positioned substantially entirely along at least two sides of the periphery of a transparent region. Likewise, a variety of means of attachment of the retaining ears may similarly be provided. For instance, the retaining ears may be provided to the support sheet by means of adhesive, welding or by other application methods, or the retaining ears may be formed by cutouts in the support sheet into which the corners/edges of the transparency means may be provided.

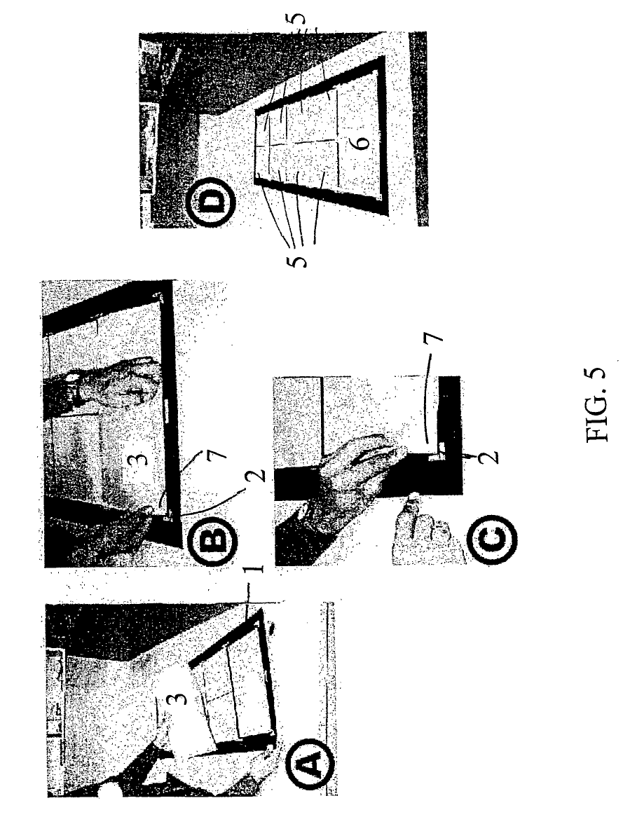

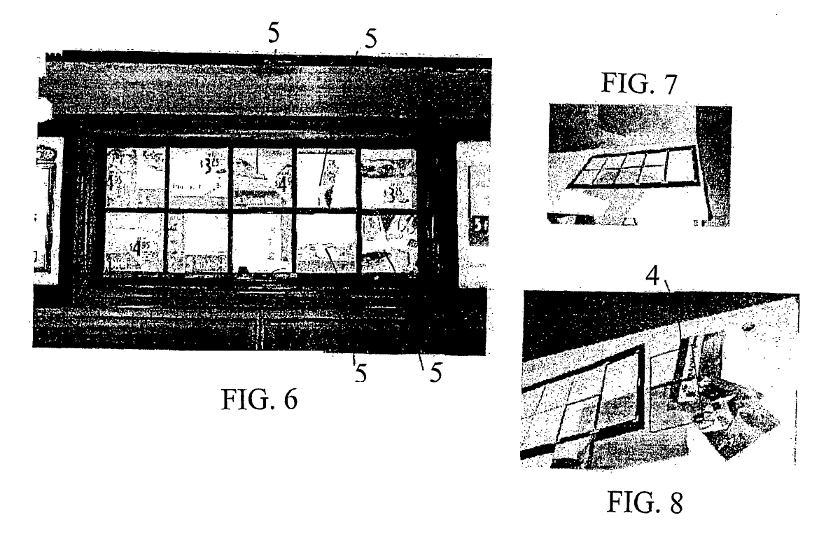

FIG. 5 illustrates the steps by which a transparency may be applied to the support sheet, to be retained by retaining means 2. As shown in FIG. 5(a), in this case illustrating the positioning of larger transparency 6 on to the support sheet 1, the transparency is prepared ready for application to the support sheet. As illustrated in FIG. 5(b), the transparency is then positioned such that it's corners 7 are positioned proximal to the retaining means 2, such that the corners may be touching behind the ears as shown in FIG. 5(c). The resultant positioning of a plurality of transparencies is shown in FIG. 5(d). FIG. 6 illustrates an alternative arrangement of a display means, in this case, showing ten equally sized transparent regions 5. As illustrated in FIGS. 6 to 9, the support sheet, however, is the identical support sheet to that used in FIGS. 2 through 5, having the eight smaller transparent regions 5, and the one larger transparent region 6. A comparison of FIG. 7 with that of FIG. 3 will illustrate similarities. In this case, however, an additional “image divider means” 4 (see FIG. 8) is utilised to visibly divide the larger transparent region 6 (FIG. 2) into a pair of smaller transparent regions 5, of equal size to the small transparent region shown in FIG. 6. The resultant appearance is that shown in FIG. 6 where ten equally sized images may be displayed.

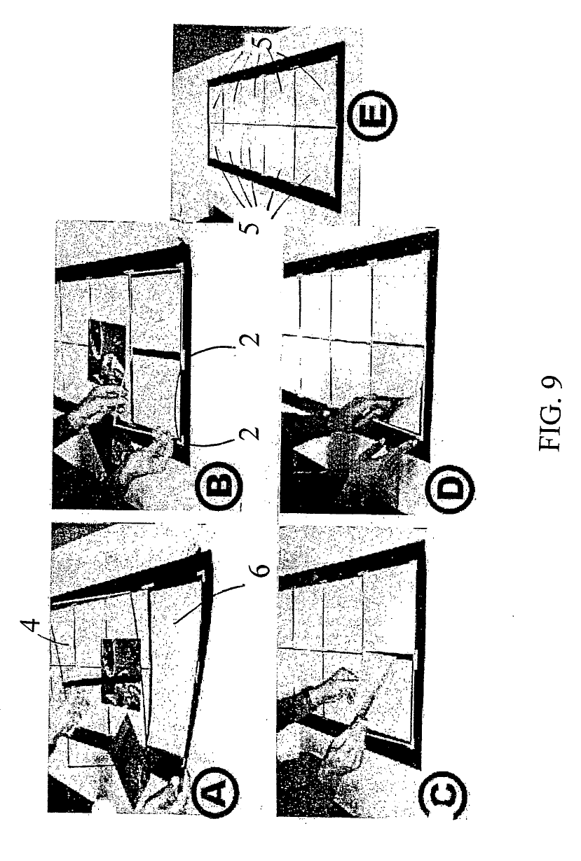

FIG. 9 illustrates the additional step required from that of FIG. 5, utilising the divider means 4. Prior to installation of the two smaller images, as shown in FIG. 9(a), the divider means 4 is installed, being retained by retaining means 2 already provided on the support sheet 1. FIG. 9(b) illustrates provision of additional retaining ears located intermediate the corners along the longitudinal edge of the transparent region. Once the divider means 4 is provided into position, the transparency means may then be installed as shown in FIGS. 9(c) and 9(d), to achieve the final appearance shown in FIG. 9(e), of having ten equally sized regions 5.

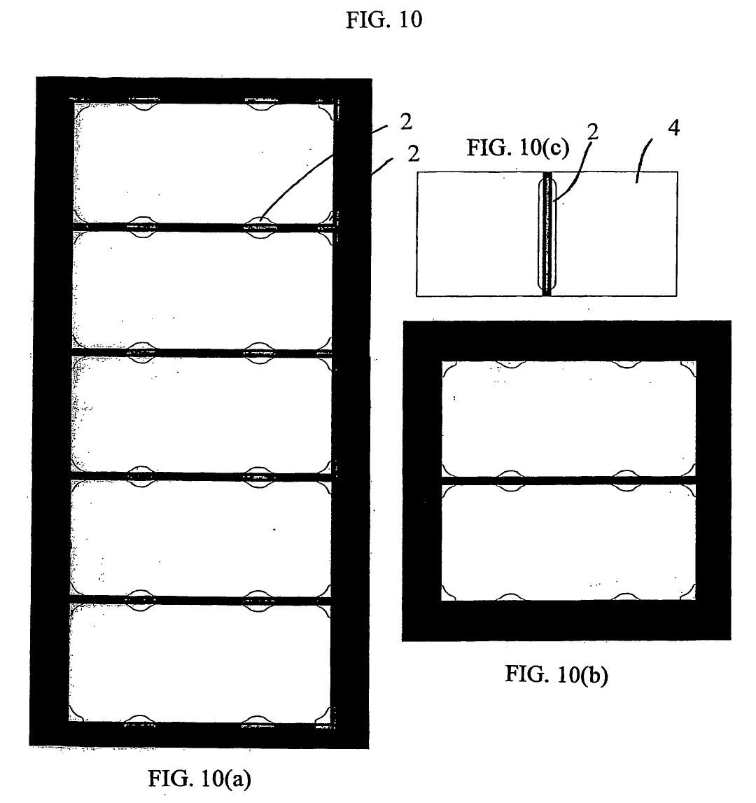

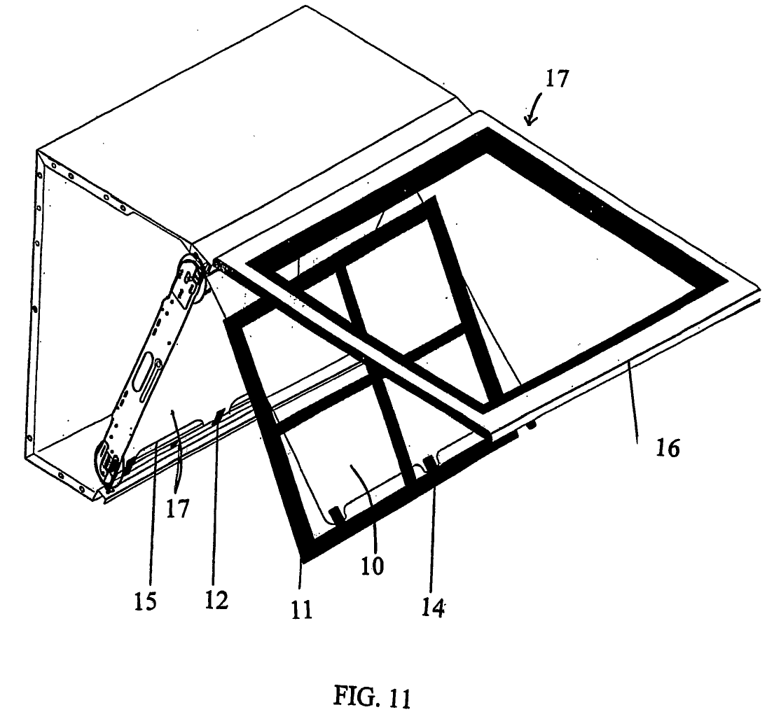

For further explanation, preferred but non-limiting embodiments of the retaining ears 2 are illustrated in FIG. 10, FIG. 10(a) illustrating an arrangement showing five equally sized regions, FIG. 11(b) illustrating an arrangement showing two equally sized regions, and, FIG. 10(c) illustrating a divider means 4 which may be used to split one of the regions of FIGS. 10(a) or 10(b), FIG. 10(c) also showing an elongate form of retaining.

FIG. 11 illustrates a diagram showing how the display means 11 may be supplied/removed from the display device. At the time of installation of the display means 11 into the display device of FIG. 11, it should be understood that one or more translite may be already attached to the display means, although for ease of understanding, the images on the translite are not shown in FIG. 11. A translite cover 10, which is a transparent flexible sheet, may be at least partly removed, as shown, from the carrier 17, by the separation of cover fastening tabs 14 from bottom fastening tabs 12. The display means 11 is then provided under the cover 10, and the cover is applied to the carrier 17 by means of fastening tabs 14. The guide 15 assists in the location of the display means 1 1. The frame door 16 is then closed.

It will be appreciated that both the translite 13 and the cover 10 must be formed of thin transparent flexible material, such as polyvinylchloride (PVC), polycarbonate and/or polypropylene. Any other alternative material may be used. The material preferably has the characteristics of not yellowing with age, and is preferably a thin, tough, weldable material, capable of rotating with the substrate of the display device. It will be appreciated that the provision of the cover 10 prevents fat and grease, etc., from affecting the translite, such materials being readily present in fast-food premises wherein the device of the present invention is typically used.

It will be appreciated that, in the utilisation of the display means of the present invention in conjunction with the display device disclosed in WO94/28534, it should be embodied in substantially flexible material, such that it can flexibly rotate with the carrier about the rollers of the display device of WO94/28534, as illustrated in FIG. 1.

It will be appreciated that a wide variety of images may be provided on the transparencies, including pictures, designs, advertising material and other images.

It will be further appreciated that in the manufacture of the display means of the present invention, a variety of techniques may be utilised. For example, the support sheet may be formed in a variety of manners, including, but not limited to, apply an opaque material to particular regions of a transparent sheet material, either by a layer of adhesive material such as a laminate, or, by screen printing opaque areas on to a clear sheet material. Likewise, the retaining ears may be embodied in a variety of formats, such as by utilising adhesives, by welding, or by other application methods. The retaining ears may either be spaced from the support sheet, or, could be formed by creating slits in the support sheet into which the transparency means may then be slotted for retention.

It will be appreciated that by utilisation of the display means of the present invention, display images of a variety of shapes and sizes may be created and easily modified in a manner which is not costly in comparison to the methods hereinbefore known.

It will be appreciated that numerous variations and modifications to the present invention will, however, be understood to persons skilled in the art. All such variations and modifications should be considered to be within the scope of the present invention as broadly hereinbefore described and as hereinafter claimed.

1. A display means for a display device,
the display device including:
at least two rotatable roller members located in substantially parallel spaced apart relationship,
a carrier means, tightly supported by and rotatable about said rollers in a bandlike configuration and adapted to receive at least one display means thereon,
each of said carrier means and said display means being constructed at least partially of substantially flexible and translucent material, and,
illumination means, provided behind at least a portion of said carrier means, to illuminate a viewing portion of said carrier means and said display means thereon,
characterised in that said display means is substantially flexible and adapted to be removably inserted on said carrier means and behind a flexible cover, said display means including:
a support sheet, having a plurality of substantially transparent regions each surrounded by a border;
retaining means, embodied as ears located at corner positions and/or locations intermediate thereto about the periphery of each border on said support sheet; and,
a plurality of transparency means, each adapted to be removably retained within a border by a respective retaining means, each said transparency means including an image to be viewed through a respective transparent region of said support sheet.

2. A display means as claimed in claim 1, wherein said retaining ears are positioned substantially entirely along at least two sides of the periphery of said transparent region(s).

3. A display means as claimed in claim 1 or 2, further including:
image divider means, embodied as a sheet member adapted to be retained proximal to said support sheet by said retaining means, said image divider means including at least one opaque border to visibly divide a transparent region of said support sheet into a plurality of regions for display of transparencies therethrough.

4. A display means as claimed in any one of claims 1 to 3, wherein said image provided on said transparency includes a picture, design, advertising material or other image.

5. A display means as claimed in any one of claims 1 to 4, wherein said retaining ears are applied to said support sheet be adhesive, welding or by other application method(s).

6. A display means as claimed in any one of claims 1 to 5, wherein said support sheet is formed to have transparent region(s) by applying an opaque material to particular regions of a transparent sheet material, either by a layer of adhesive material such as a laminate, by screen printing onto said transparent sheet, or the like.

7. A display means as claimed in any one of claims 1 to 6, wherein said sheet material and/or said transparency means is substantially formed of flexible material such as polycarbonate and/or polypropylene sheet material.

8. A display means, including:
a support sheet having a plurality of substantially transparent regions, each surrounded by a border;
retaining means, embodied as ears located at corner positions and/or intermediate thereto about the periphery of each border on said support sheets;
at least one image divider means, embodied as a sheet member adapted to be retained proximal to said support sheet by said retaining means, said image divider means including at least one further border thereon to visibly further divide said support sheet into additional transparent regions, said image divider means including further retaining means located proximal to said further border; and,
a plurality of transparency means, each adapted to be removably retained within said borders by the respective retaining means, each said transparency means including an image to be viewed through a respective transparent region of said support sheet.

9. A display means as claimed in claim 8, wherein said retaining ears are positioned substantially entirely along at least two sides of the periphery of said transparent region(s).

10. A display means as claimed in claim 8 or 9, wherein said image provided on said transparency includes a picture, design, advertising material or other image.

11. A display means as claimed in any one of claims 8 to 10, wherein said retaining ears are applied to said support sheet be adhesive, welding or by other application method(s).

12. A display means as claimed in any one of claims 8 to 11, wherein said support sheet is formed to have transparent region(s) by applying an opaque material to particular regions of a transparent sheet material, either by a layer of adhesive material such as a laminate, by screen printing onto said transparent sheet, or the like.

13. A display means as claimed in any one of claims 8 to 12, wherein said sheet material and/or said transparency means is substantially formed of flexible material such as polycarbonate and/or polypropylene sheet material.

14. A method of manufacturing a display means, substantially as herein described.

15. A method of using/changing displayed images using a display means, substantially as herein described.

16. A display means, substantially as herein described with reference to the accompanying drawings.
